(19) United States
(12) Patent Application Publication
(10) Pub. No.: US 2007/0248480 A1
(43) Pub. Date: Oct. 25, 2007

(54) Multiple Section External Gear Pump With the Internal Manifold

(75) Inventors: James M. Mayer, Cedar Falls, IA (US); Gary B. Bamber, Cedar Falls, IA (US); Jeffrey M. Krogmann, Center Point, IA (US)

Correspondence Address: MILLER, MATTHIAS & HULL, ONE NORTH FRANKLIN STREET, SUITE 2350, CHICAGO, IL, 60606, US

(73) Assignee: Viking Pump, Inc., Cedar Falls, IA (US)

(21) Appl. No.: 11/379,457

(22) Filed: Apr. 20, 2006

(51) Int. Cl. F01C 1/18; F01C 1/24; F03C 2/00

(52) U.S. Cl. 418/206.1; 418/205

(57) ABSTRACT

A multiple section, expandable external gear pump is disclosed that includes a single inlet in communication with each gear set without a manifold disposed external to the casing. The pump also includes a single outlet in communication with each gear set without an outlet manifold disposed external to the pump casing. The casing includes a head and an end casing/bracket section with one or more individual casing sections sandwiched therebetween. Each casing section accommodates its own drive gear/idler gear pair and each gear pair is in communication with a common inlet chamber and a common outlet chamber without any manifold structures disposed external to the pump casing. The end casing/bracket may also accommodate a gear pair.

### BACKGROUND

1. Technical Field

An external gear pump is disclosed with multiple, discrete pumping sections. The separate pumping sections or separate pumps are fed by a single inlet and communicate with a single outlet. Manifold functions between the inlet and pump sections and between the pump sections and outlet are disposed within the pump casing thereby requiring only a single inlet pipe connection and a single outlet pipe connection without any manifolds external to the pump casing.

2. Description of the Related Art

External gear pumps are a popular pumping principle and are often found in lubrication pumps in machine tools, in fluid power transfer units, and as oil pumps in engines.

External gear pumps are similar in pumping action to internal gear pumps in that two gears come into and out of mesh to produce flow. However, an external gear pump uses two identical gears rotating against each other—one gear is driven by a motor and it in turn drives the other gear. In contrast, the gears of an internal pump rotate in the same direction as a smaller inner idler gear is disposed within a larger outer rotor gear.

Each gear of an external pump is supported by a shaft with bearings on both sides of the gear. As the external pump gears come out of mesh, they create expanding volume on the inlet side of the pump. Liquid flows into the cavity and is trapped by the gear teeth as they rotate. Liquid travels around the interior of the external pump casing in the pockets between the teeth and the casing. In contrast to an internal gear pump, liquid does not pass between the external pump gears; it travels circumferentially around the gears. The meshing of the external pump gears forces liquid through the outlet port under pressure.

External gear pumps may employ spur, helical, and herringbone gears. Helical and herringbone gears offer a smoother flow than spur gears, although all gear types provide relatively smooth operation. Large-capacity external gear pumps typically use helical or herringbone gears. Small external gear pumps usually operate at 1750 or 3450 rpm and larger models operate at speeds up to 640 rpm. External gear pumps handle viscous and watery-type liquids, but speed must be properly set for thick liquids. Reduced speeds with high-viscosity liquids results in greater efficiency.

The design of external gear pumps allows them to be made to close tolerances. Tighter internal clearances provide for a more reliable measure of liquid passing through a pump and for greater flow control. Because of this, external gear pumps are popular for precise transfer applications involving polymers, fuels, and expensive liquids. Because the gears are supported on both sides, external gear pumps are quiet-running and are routinely used for high-pressure applications such as hydraulic applications. With no overhung bearing loads, the rotor shaft typically cannot deflect and wear prematurely.

To increase capacity or functions while employing a single power source, external gear pumps may be provided with multiple sections. Each section of the pump includes a pair of gears disposed within a pump chamber. The pump chambers are separated by a plate through which the pump shafts pass. Seals are disposed between the shafts and the separation plate to prevent cross communication between the pump chambers.

While providing multiple pump sections (or multiple pumps within a single pump casing) is a convenient and inexpensive way to increase capacity and provide versatility, the employment of discrete pump sections requires the use of multiple inlets or a manifold on the intake side as well as multiple outlets or a manifold on the output side. Thus, with the multiple inlets and outlets, the size or footprint of the pump increases. In certain cases, the use of exterior manifolds is not permissible due to space limitations. Further, the requirement of an additional manifold or manifolds as additional expense and can result in sealing problems as leakage from port misalignment is a common problem.

Thus, improvements in the design of multiple section external gear pumps are needed that simplify porting and provide high but variable capacities in small spaces.

### SUMMARY OF THE DISCLOSURE

In satisfaction of the aforenoted needs, an improved expandable external gear pump is disclosed without input or output manifolds. A single inlet is provided that is in fluid communication with each pump chamber and a single outlet is provided that is also in communication with each pump chamber. Therefore, the pump sections or pumps may be expanded or contracted in number and because the pump includes no inlet or outlet manifolds, such a change in pump capacity is simple and straightforward.

In an embodiment, an external gear pump is disclosed which comprises a drive shaft that passes through a plurality of drive gears. Each drive gear is enmeshed with a driven gear or idler gear, thereby providing a plurality of gear pairs or gear sets. Each gear pair or gear set includes one drive gear and one driven or idler gear. Each of the gear pairs is disposed within a casing. The casing comprises a single inlet and defines a single inlet chamber that links the single inlet to each gear pair without an inlet manifold external to the casing.

In a refinement, the casing comprises a single outlet and the casing also defines a single outlet chamber that links each gear pair with the single outlet without an outlet manifold external to the casing.

In another refinement, the casing comprises a plurality of stacked casing sections connected to a head that defines the inlet and the outlet. Each casing section accommodates one of the gear pairs. The stacked casing sections, together with the head, defined a single inlet chamber and the single outlet chamber. Although the disclosed pump does not include external inlet and outlet manifolds, the manifold functions are essentially internal to the pump casing and therefore the pump casing provides inlet and outlet manifold functions.

In another refinement, one of the casing sections is an end casing that receives the drive shaft and includes a means for connecting the casing to the pump motor assembly.

In another refinement, the drive and idler gears are mounted to a common driven or idler shaft.

In another refinement, the drive and idler shafts are supported by at least the head and end casing. In a further refinement, each casing section provides a support structure for both of the gear shafts.

In an embodiment, an expandable multiple section external gear pump is disclosed that does not include an inlet manifold that is external to the pump casing.

In an embodiment, an expandable multiple section external gear pump is disclosed that does not include an outlet manifold that is an external to the pump casing.

In a refinement, common input and output chambers are provided by a multiple section casing assembly without the need for external input or output manifolds and the piping associated therewith.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is a front perspective view of a multiple section external gear pump with internal manifolds made in accordance with this disclosure;

FIG. 2 is a front plan view of the pump shown in FIG. 1;

FIG. 3 is a rear plan view of the pump shown in FIGS. 1-2;

FIG. 4 is a left side view showing the inlet of the pump illustrated in FIGS. 1-3;

FIG. 5 is a right side view showing the mounting flange of the pump illustrated in FIGS. 1-4;

FIG. 6 is a sectional view illustrating one set of gears and the inlet and outlet passageways of the pump shown in FIGS. 1-5;

FIG. 7 is a sectional perspective view of the pump shown in FIGS. 1-6;

FIG. 8 is a sectional perspective view of the pump shown in FIGS. 1-7; and

FIG. 9 is an exploded view of the pump as shown in FIGS. 1-8.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

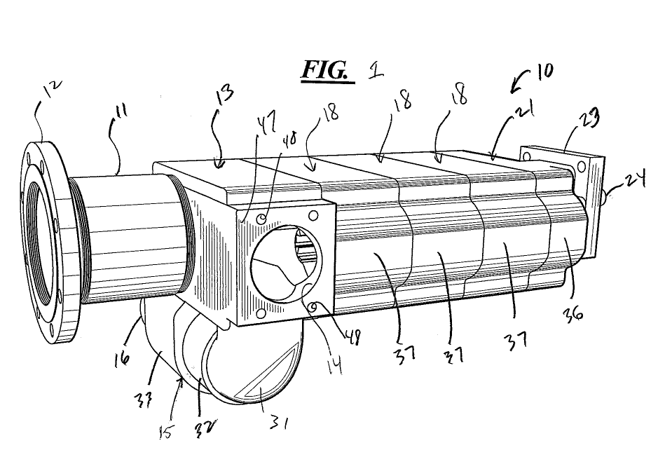

Turning to FIG. 1, a multiple section external gear pump 10 is disclosed featuring and inlet conduit 11 connected to a mounting flange 12. The conduit 11 connects the flange 12 to a casing head 13 which, as shown in FIG. 1, includes a single outlet 14. The casing head 13 also includes relief valve piping shown generally at 15 that is connected to a relief valve (not shown) disposed within the bonnet 16 and beneath the cap 17 as shown in FIG. 3.

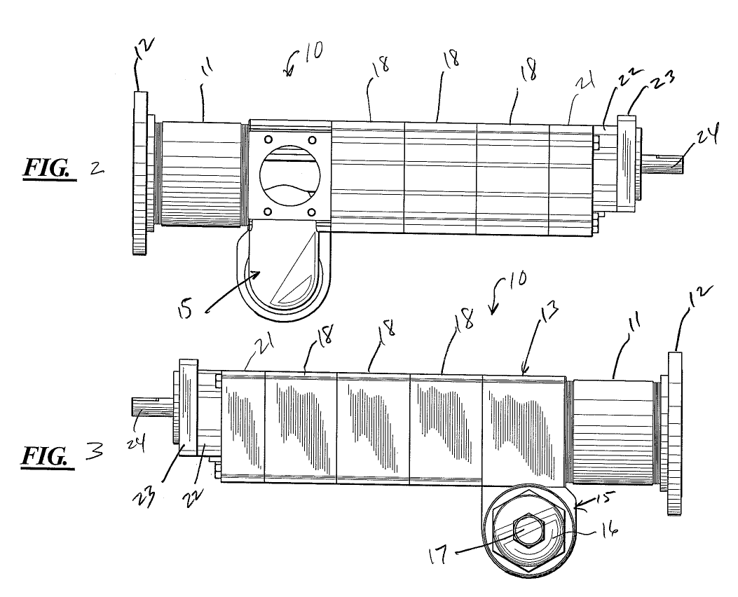

The head 13 connects the inlet conduit 11 to a plurality of casings shown generally at 18 and FIGS. 1-3. The casings or casing sections 18 are disposed between the head 13 and an end casing/bracket 21 which, in turn, is connected to a housing 22 and flange 23 which receive the drive shaft 24 (see FIGS. 2-3).

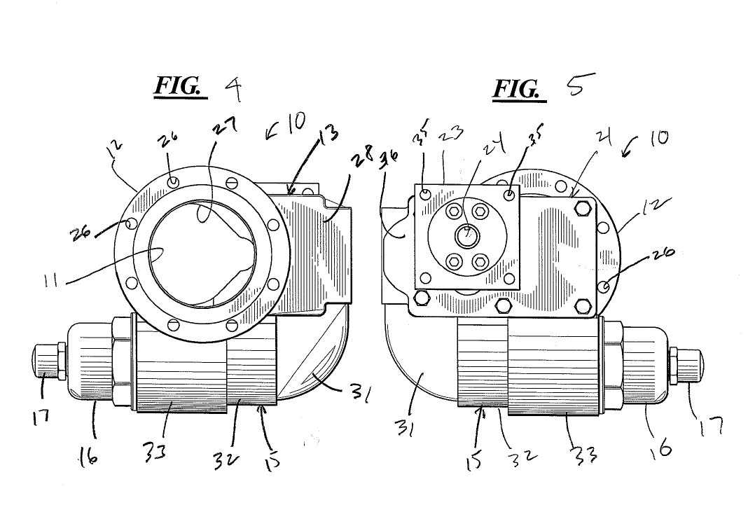

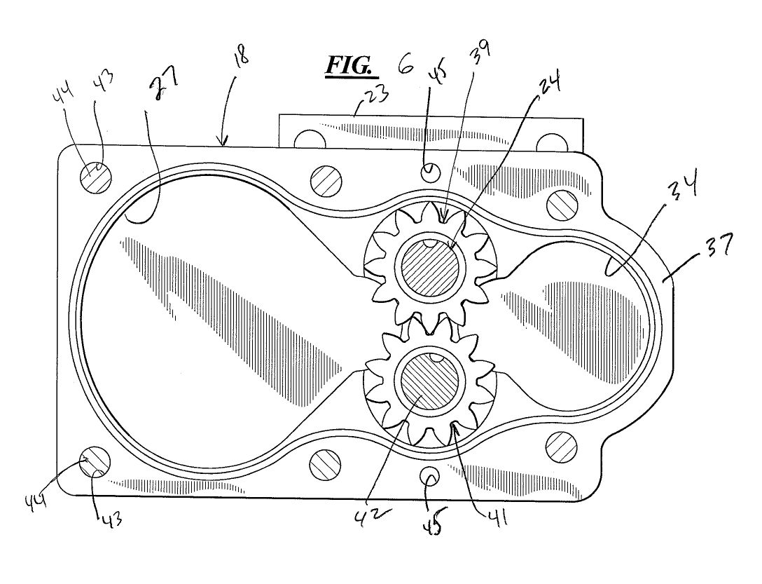

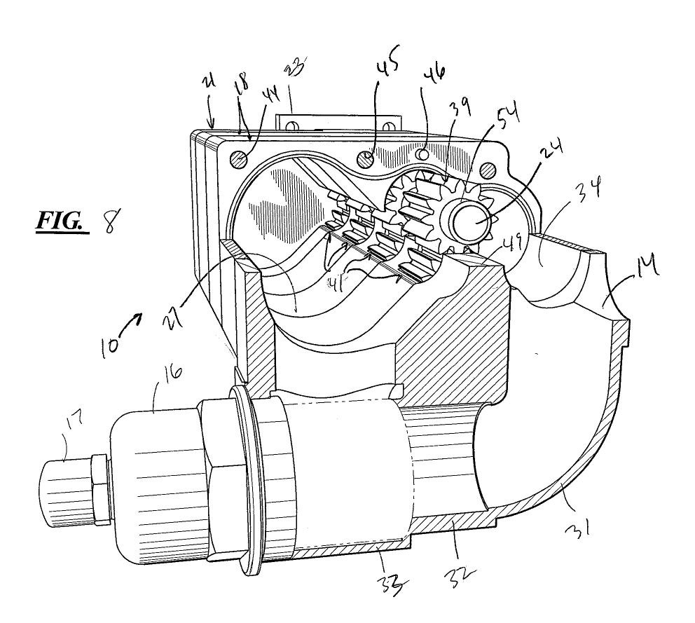

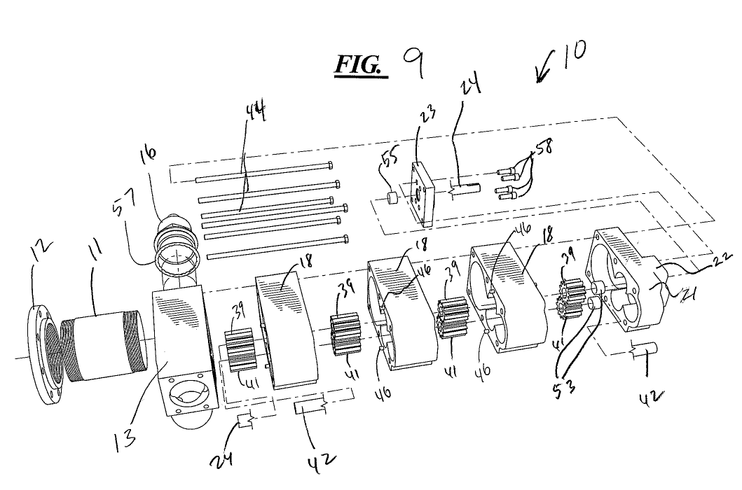

Turning to FIGS. 4-5, the opposing ends of the pump 10 housing are shown in greater detail along with the relief valve piping 15. Turning first to FIG. 4, the flange 12 includes a plurality of bolt holes 26 for mounting purposes. As seen in FIG. 4, the inlet 11 leads into an inlet chamber 27 that extends through and is also formed by the head 13, casings 18, and the end casing/bracket 21 as will be explained in greater detail below in connection with FIGS. 7-8. The head 13 includes an outlet extension 28 which is in communication with the outlet 14 (FIG. 1) and the relief valve piping assembly 15, which includes an elbow 31, stepped sections 32, 33, of the latter of which is threadably connected to the bonnet 16. The bonnet 16 houses a conventional relief valve (not shown) which is in communication with the relief valve cap 17.

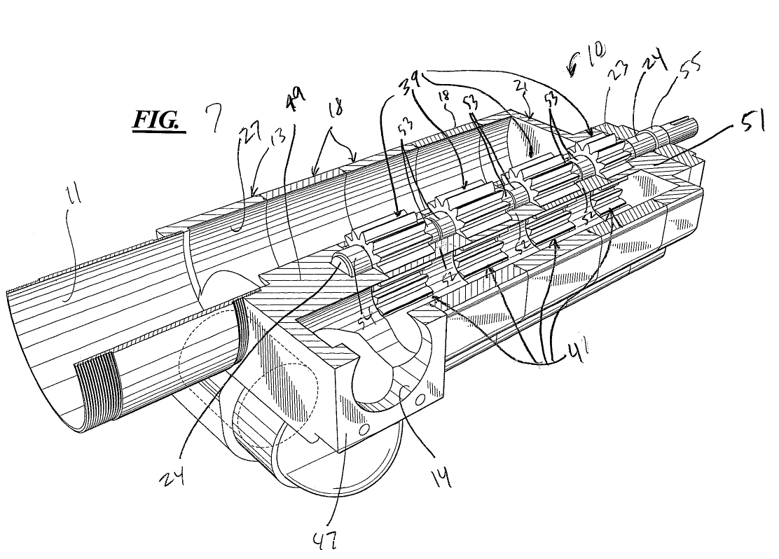

Turning to FIG. 5, the end casing/bracket 21 is connected to the flange 23 which receives the drive shaft 24. The flange 23 also includes bolt holes 35 for mounting purposes. An extension 36 of the end casing/bracket 21 also helps to form the output chamber 34 (see FIG. 6) with the extensions 37 of the casings 18 as described in greater detail below in connection with FIGS. 6-8. Like the inlet chamber 27, the outlet chamber 34 extends down the housing of the pump 10 and through the head 13, casings 18 and casing/bracket 21.

Turning to FIG. 6, a single casing 18 is illustrated. The casing 18 includes through openings that partially define the inlet chamber 27 and the outlet chamber 34. The inlet chamber 27 side of the casing 18 is in communication with the inlet 11 and the outlet chamber 34 side of the casing 18 is in communication with the outlet 14. Fluid disposed within the inlet 27 side of the casing 18 is directed towards the opposing gears 39, 41. The gear 39 is mounted to the drive shaft 24 along with three other like drive gears 39 as shown in FIG. 7. The idler gear 41 is mounted to an idler shaft 42 along with three other like idler gears 41 as shown in FIG. 7. While the gears 39, 41 are of the spur type, it will be noted that other gear types can be used with the pump 10 of this disclosure, including, but not limited to, helical and herringbone gears. Other gear designs will be apparent to those of ordinary skill in the art.

As shown in FIG. 9 below, the casing 18 also includes a plurality of through holes 43 for accommodating connecting rods 44. The casing 18 also includes one or more recesses 45 for accommodating one or more guideposts 46 (see FIGS. 8 and 9) of an adjacent casing 18 to facilitate assembly of the stacked structure of the pump 10.

Turning to FIGS. 7-8, it will be noted that the pump 10 as shown includes four sets of gears to 39, 41 by way of its incorporation of three casings 18. However, the number of gear sets 39, 41 can be expanded beyond four or reduced to less than four. In the design of the pump 10, one gear set 39, 41 is disposed in the casing/bracket 21 and the remaining three gear sets 39, 41 are disposed within the individual casings 18. Thus, if the casings 18 are reduced to two in number, only three gear sets 39, 41 are provided. Further, if only a single casing 18 is provided, only two gear sets 39, 41 are provided. A single pair of gears 39, 41 can be provided by the pump design 10 and shown if no casings 18 are stacked between the end casing/bracket 21 and the head 13. Further, additional casings 18 may be stacked between the end casing 21 and head 13. In short, the pump 10 is expandable or contractible beyond the configuration shown herein.

Further, instead of an outlet manifold being connected to the outlet chamber or chambers 34, the design of the head 13 enables only a single outlet 14 that is in communication with the continuous outlet chamber 34 and thereby permitting only a single outlet pipe or pipe connection to be made at the outlet 14 (see FIGS. 1 and 7). The mounting surface 47 that surrounds the outlet 14 of the head 13 includes bolt holes 48 for making the single outlet pipe connection. This is far more convenient and space conserving than an outlet manifold which would include multiple outlets fed to a single conduit. Similarly, the single inlet 11 feeds the inlet chamber 27 which is formed by the head 13, casings 18 and end casing/bracket 21 thereby eliminating the need for an inlet manifold.

With the stacked casing 18 structure sandwiched between the head 13 and end casing/bracket 21 of the disclosed design, the pump 10 is both expandable and contractible in terms of output capacity. Further, because the pump 10 does not require inlet or outlet manifolds, modifying the pump 10 to increase or decrease capacity merely involves changing drive shafts 24 and idler shafts 42 (i e., changing shaft length) and the number of casings 18. No modifications or substitutions need be made to the inlet 11 or outlet 14 because of the internal manifold structure of the pump 10.

Turning to FIG. 7, the inlet conduit 11 may be threadably connected to the head 13 although other connection mechanisms may be employed. The head 13 includes a support structure 49 for rotatably accommodating the drive shaft 24 and idler shaft 42 (not shown in FIG. 7). Similarly, the end casing 21 also includes a support structure 51 for supporting the shafts 24, 42. Each casing 18 also includes center support blocks 52 that rotatably support bushings 53 disposed between adjacent gear sets 39, 41. An end or outboard bushing or bearing 54 for the drive shaft 24 is shown in FIGS. 7-8 as well. An inboard support bearing for the shaft 24 is also shown at 55.

Each gear set 39, 41 is isolated from its adjacent to gear set 39, 41 by the bushings/seals 53 so that each gear set 39, 41 essentially acts as an independent pump, only minimally affecting adjacent pumps or gear sets 39, 41.

The construction of the pump 10 is illustrated in FIG. 9. The flange 12 may be threadably coupled to pipe 11 which may be threadably coupled to the head 13. A gasket 57 is sandwiched between the bonnet 16 in the head 13. The drive shaft 24 and idler shaft 42 are fed through their respective gears 39, 41, casings 18, 21 and bushings 53. The casings 18, 21 are secured to the head 13 by the connecting rods 44. The flange 23 is secured to the end casing/bracket 21 by the bolts or threaded fasteners 58.

Thus, an improved expandable external gear pump 10 is shown and described with internal input and output manifolds that render the pump 10 more compact and easier to expand or contract in terms of pump capacity. The pump 10 is more suitable for confined spaces and because of the ease in which it can be expanded or contracted in terms of pump capacity, the pump 10 is ideal for easy modification by the end user.

While only certain embodiments have been set forth, alternatives and modifications will be apparent from the above description to those skilled in the art. These and other alternatives are considered equivalents and within the spirit and scope of this disclosure and the appended claims.

What is claimed:

1. An external gear pump comprising:
a drive shaft, the drive shaft passing through a plurality of drive gears;
each drive gear being enmeshed with a driven gear thereby providing a plurality of gear pairs, each gear pair including one of the drive gears and one of the driven gears, each of the gear pairs being disposed within a casing;
the casing comprising a single inlet and a single inlet chamber linking the single inlet to each gear pair without an inlet manifold external to the casing.

2. The pump of claim 1 wherein the casing comprises a single outlet and a single outlet chamber linking each gear pair with the single outlet without an outlet manifold external to the casing.

3. The pump of claim 1 wherein the casing comprises a plurality of stacked casing sections connected to a head that defines the inlet and the outlet, each casing section accommodating one of the gear pairs.

4. The pump of claim 3 wherein one of the casing sections is an end casing that includes an opening for receiving the drive shaft.

5. The pump of claim 4 wherein the end casing and the head support inboard and outboard ends of the drive shaft respectively.

6. The pump of claim 5 further comprising a driven shaft passing through each driven gear, the head and end casing supporting inboard and outboard ends of the driven shaft respectively.

7. The pump of claim 1 wherein the casing comprises a head defining the inlet and the outlet, and end casing and at least one middle casing section sandwiched between the head and the end casing.

8. The pump of claim 7 wherein the end casing and the head support inboard and outboard ends of the drive shaft respectively.

9. The pump of claim 8 further comprising a driven shaft passing through each driven gear, the head and end casing supporting inboard and outboard ends of the driven shaft respectively.

10. The pump of claim 2 wherein the casing comprises a plurality of stacked casing sections connected to a head that defines the inlet and the outlet, each casing section accommodating one of the gear pairs.

11. The pump of claim 10 wherein one of the casing sections is an end casing that includes an opening for receiving the drive shaft.

12. The pump of claim 11 wherein the end casing and the head support inboard and outboard ends of the drive shaft respectively.

13. The pump of claim 12 further comprising a driven shaft passing through each driven gear, the head and end casing supporting inboard and outboard ends of the driven shaft respectively.

14. The pump of claim 2 wherein the casing comprises a head defining the inlet and the outlet, and end casing and at least one middle casing section sandwiched between the head and the end casing.

15. The pump of claim 14 wherein the end casing and the head support inboard and outboard ends of the drive shaft respectively.

16. The pump of claim 15 further comprising a driven shaft passing through each driven gear, the head and end casing supporting inboard and outboard ends of the driven shaft respectively.

17. An external gear pump comprising:
a drive shaft, the drive shaft passing through a plurality of drive gears;
each drive gear being enmeshed with a driven gear thereby providing a plurality of gear pairs, each gear pair including one of the drive gears and one of the driven gears, the gear pairs being disposed within a casing;
the casing comprising a single outlet and a single outlet chamber linking each gear pair to the single outlet without an outlet manifold external to the casing.

18. The pump of claim 17 wherein the casing comprises a single inlet and a single inlet chamber linking each gear pair with the single inlet without an inlet manifold external to the casing.

19. The pump of claim 18 wherein the casing comprises a plurality of stacked casing sections connected to a head that defines the inlet and the outlet, each casing section accommodating one of the gear pairs.

20. The pump of claim 19 wherein one of the casing sections is an end casing that includes an opening for receiving the drive shaft.
